(19) United States
(12) Patent Application Publication
(10) Pub. No.: US 2025/0389245 A1
(43) Pub. Date: Dec. 25, 2025

(54) FUEL INJECTOR, ENGINE AND VEHICLE

(71) Applicants: ZHEJIANG GEELY HOLDING GROUP CO., LTD., Hangzhou (CN); ZHEJIANG INTELLIGENT TRANSPORTATION TECHNOLOGY INNOVATION CENTER, Ningbo (CN)

(72) Inventors: Feng GE, Hangzhou (CN); Yang ZHAO, Hangzhou (CN); Jianxiong MA, Hangzhou (CN); Litao ZHANG, Hangzhou (CN); Zhihui SONG, Hangzhou (CN); Yan LIU, Hangzhou (CN); Yuan SHEN, Hangzhou (CN); Guosong XUE, Hangzhou (CN)

(73) Assignees: ZHEJIANG GEELY HOLDING GROUP CO., LTD., Hangzhou (CN); ZHEJIANG INTELLIGENT TRANSPORTATION TECHNOLOGY INNOVATION CENTER, Ningbo (CN)

(21) Appl. No.: 19/316,109

(22) Filed: Sep. 2, 2025

Related U.S. Application Data
(63) Continuation of application No. PCT/CN2024/098220, filed on Jun. 7, 2024.

(30) Foreign Application Priority Data
Jun. 14, 2023 (CN) 202310707055.5

(51) Int. Cl. F02M 51/06; F02M 61/10

(52) U.S. Cl. CPC F02M 51/061; F02M 61/10

(57) ABSTRACT

A fuel injector includes: a valve sleeve provided with a valve cavity and a fuel injection port communicated with the valve cavity; a needle valve assembly suspended or movably provided in the valve cavity, and the outer circumference of the needle valve assembly being spaced apart from the inner wall of the valve cavity; a magnetic suspension structure provided at the needle valve assembly; and an electromagnetic drive assembly provided at the valve sleeve. The electromagnetic drive assembly generates magnetic force when powered on and cooperates with the magnetic suspension structure to make the needle valve assembly suspend or move in the valve cavity along the axial direction of the valve sleeve to open or close the fuel injection port.

### CROSS-REFERENCE TO RELATED APPLICATIONS

This application is a continuation application of International Application No. PCT/CN2024/098220, filed on Jun. 7, 2024, which claims priority to Chinese Patent Application No. 202310707055.5, filed on Jun. 14, 2023. All of the aforementioned applications are incorporated herein by reference in their entireties.

### TECHNICAL FIELD

The present application relates to the technical field of engine fuel injection, and in particular to a fuel injector, an engine and a vehicle.

### BACKGROUND

The fuel injector is a high-precision device with a large dynamic flow range, strong anti-clogging and anti-pollution capabilities, and good atomization performance. The fuel injector can receive the injection pulse signal sent by the Electronic Control Unit (ECU) and accurately control the fuel injection amount. It is the core component of the electronically controlled gasoline injection system of the vehicle engine and has an important impact on the fuel combustion and emission performance of the vehicle.

At present, the fuel injectors in the industry usually adopt the structural design that guides the friction movement of the needle valve in the valve sleeve, and the friction movement of the needle valve is used to close or open the fuel injector. However, severe friction and wear may occur during the movement of the needle valve, which tends to result in abnormal fuel injection.

### SUMMARY

The main purpose of the present application is to provide a fuel injector, an engine and a vehicle, aiming to solve the technical problem of severe friction and wear of the needle valve in the related art.

To achieve the above purpose, an embodiment of the present application provides a fuel injector, the fuel injector including:
a valve sleeve provided with a valve cavity and a fuel injection port communicated with the valve cavity;
a needle valve assembly suspended or movably provided in the valve cavity;
an electromagnetic drive assembly provided at the valve sleeve; and
a magnetic suspension structure provided at the needle valve assembly,
wherein an outer circumference of the needle valve assembly is spaced apart from an inner wall of the valve cavity; and
the electromagnetic drive assembly generates magnetic force when powered on and cooperates with the magnetic suspension structure to make the needle valve assembly move axially along the valve sleeve in the valve cavity to open or close the fuel injection port.

In an embodiment, the magnetic suspension structure includes a permanent magnet provided at the needle valve assembly, at least three permanent magnets are provided at intervals along a circumference of the needle valve assembly, and each of the permanent magnets is correspondingly provided with a set of the electromagnetic drive assemblies.

In an embodiment, each set of the electromagnetic drive assemblies includes a first electromagnetic coil and the permanent magnet, the first electromagnetic coil is provided at the inner wall of the valve cavity and is provided opposite to the permanent magnet; the permanent magnet is provided at the needle valve assembly, and the permanent magnet is provided with a first magnetic pole and a second magnetic pole in a movement direction of the needle valve assembly; a direction of the magnetic force generated by the first electromagnetic coil is adjustable by changing a direction of the current, and the first electromagnetic coil cooperates with the first magnetic pole or the second magnetic pole to drive the needle valve assembly to move away from or close to the fuel injection port; the magnetic forces generated by the first electromagnetic coils in a plurality sets of the electromagnetic drive assemblies when energized are in a same direction, and simultaneously attract or repel the needle valve assembly, and the needle valve assembly is in a suspended state.

In an embodiment, each set of the electromagnetic drive assemblies further includes a second electromagnetic coil, the first electromagnetic coil and the second electromagnetic coil are stacked in the movement direction of the needle valve assembly, the magnetic forces generated by the first electromagnetic coil and the second electromagnetic coil when energized are in a same direction, the magnetic force generated by the first electromagnetic coil cooperates with the first magnetic pole and the magnetic force generated by the second electromagnetic coil cooperates with the second magnetic pole to jointly drive the needle valve assembly to move toward or away from the fuel injection port.

In an embodiment, each set of the electromagnetic drive assemblies further includes a third electromagnetic coil, the first electromagnetic coil, the third electromagnetic coil and the second electromagnetic coil are stacked in the movement direction of the needle valve assembly; a direction of a magnetic force generated by the third electromagnetic coil when energized is different from the direction of the magnetic force generated by the first electromagnetic coil when energized; the magnetic force generated by the first electromagnetic coil cooperates with the first magnetic pole, the magnetic force generated by the second electromagnetic coil cooperates with the second magnetic pole, and the magnetic force generated by the third electromagnetic coil cooperates with the first magnetic pole and the second magnetic pole to jointly drive the needle valve assembly to move toward or away from the fuel injection port.

In an embodiment, the fuel injector further includes:
a gap sensor, the gap sensor is provided at the inner wall of the valve cavity to detect a distance between an outer wall of the needle valve assembly and the inner wall of the valve cavity, and each set of the electromagnetic drive assembly is correspondingly provided with a gap sensor.

In an embodiment, the fuel injector further includes:
a control unit, the gap sensor and the electromagnetic drive assembly are both electrically connected to the control unit, and the control unit is configured to adjust a current value input to the electromagnetic drive assembly according to a detection value of the gap sensor.

In an embodiment, the needle valve assembly includes a valve stem, a sealing ball and a ball seat;
the permanent magnet is provided at the valve stem, an outer circumference of the valve stem is spaced apart from the inner wall of the valve cavity, and a plurality sets of the electromagnetic drive assemblies are provided along a circumference direction of the valve stem;
the sealing ball is provided at an end of the valve stem close to the fuel injection port; and
the ball seat is provided with a sealing hole communicating with the fuel injection port and the valve cavity, the sealing ball cooperates with the sealing hole.

In an embodiment, the valve stem is provide with a driving section and a sealing section adjacent to the driving section, the permanent magnet is provided at the driving section, the plurality sets of the electromagnetic drive assemblies are provided along a circumference of the driving section, the sealing ball is provided at an end of the sealing section away from the driving section, an outer diameter of the driving section is greater than an outer diameter of the sealing section, and the driving section and the sealing section are spaced apart from the inner wall of the valve cavity.

To achieve the above purpose, an embodiment of the present application further provides an engine as described in the above embodiments.

To achieve the above purpose, an embodiment of the present application further provides a vehicle as described in the above embodiments.

Compared with the related art, in a technical solution proposed in the present application, a needle valve assembly is provided in the valve cavity of the valve sleeve, and the needle valve assembly can slide in the valve cavity. Through the sliding of the needle valve assembly, the fuel injection port can be opened to enter the fuel injection state, or the fuel injection port can be closed to achieve the fuel injection stop state. At the same time, an electromagnetic drive assembly is provided in the valve cavity, and a magnetic suspension structure is provided at the needle valve assembly. The electromagnetic drive assembly will generate magnetic force when powered on. The magnetic force cooperates with the magnetic suspension structure, so that the needle valve assembly slides under the action of the magnetic force, which can prevent the elastic force attenuation caused by conventional spring drive, improve the reliability of the movement of the valve stem, and ensure the normal injection of the fuel injector. In other words, by adjusting the direction of the current input into the electromagnetic drive assembly, the direction of the magnetic force can be changed, thereby cooperating with the magnetic suspension structure to drive the needle valve assembly to move away from or close to the fuel injection port. Moreover, the magnetic force generated by the electromagnetic drive assembly can attract or repel the magnetic suspension structure, so that the needle valve assembly remains suspended in the valve cavity and is spaced apart from the inner wall of the valve cavity, thereby shielding the metal friction between the valve stem and the valve sleeve, that is, there is no friction between the valve stem and the valve sleeve, thereby reducing the friction and wear of the valve stem and preventing the valve stem and the valve sleeve from getting stuck, which may cause abnormal conditions such as the fuel injector not spraying fuel or spraying fuel frequently.

### BRIEF DESCRIPTION OF THE DRAWINGS

In order to more clearly illustrate the embodiments of the present application or the technical solutions in the related art, the drawings required for use in the embodiments or the description of the related art will be briefly introduced below. Obviously, the drawings described below are only some embodiments of the present application. For those skilled in the art, other drawings can be obtained based on the structures shown in these drawings without any creative work.

FIG. 1 is a structural schematic view of a fuel injection port of a fuel injector in a fuel injection stop state according to an embodiment of the present application.

FIG. 2 is a structural schematic view of the fuel injection port of the fuel injector in a fuel injection state according to an embodiment of the present application.

The realization of the purpose, functional features and advantages of the present application will be further explained in conjunction with embodiments and with reference to the accompanying drawings.

### DETAILED DESCRIPTION OF THE EMBODIMENTS

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by those skilled in the art without creative work are within the scope of protection of the embodiments of the present application.

It should be noted that all directional indications in the embodiments of the present application (such as up, down, left, right, front, back, etc.) are only used to explain the relative position relationship, movement status, etc. between the components under a certain specific posture (as shown in the accompanying drawings). If the specific posture changes, the directional indication will also change accordingly.

In addition, in the embodiments of the present application, descriptions such as “first”, “second”, etc. are only used for descriptive purposes and cannot be understood as indicating or implying their relative importance or implicitly indicating the number of technical features indicated. Therefore, the features defined as “first” or “second” may explicitly or implicitly include at least one of the features. In the description of the embodiments of the present application, the meaning of “multiple” is at least two, for example, two, three, etc., unless otherwise clearly and specifically defined.

In the embodiments of the present application, unless otherwise clearly specified and limited, the terms “connection”, “fixation”, etc. should be understood in a broad sense. For example, “fixation” can be a fixed connection, a detachable connection, or an integral connection; it can be a mechanical connection or an electrical connection; it can be a direct connection or an indirect connection through an intermediate medium, it can be the internal connection of two elements or the interaction relationship between two elements, unless otherwise clearly limited. For those skilled in the art, the specific meanings of the above terms in the embodiments of the present application can be understood according to specific circumstances.

In addition, the technical solutions between the various embodiments of the present application can be combined with each other, but it must be based on the fact that those skilled in the art can implement it. When the combination of technical solutions is mutually contradictory or cannot be implemented, it should be deemed that such combination of technical solutions does not exist and is not within the scope of protection required by the embodiments of the present application.

Conventional electromagnetic or piezo crystal fuel injectors are the main types of fuel injectors used in methanol fuel engines. The valve stem of the fuel injector is guided by a guide sleeve. During the movement of the valve stem, the valve stem and the guide sleeve are always in contact and there is friction and wear. In addition, the fuel itself has poor lubricity and is corrosive. After a certain period of endurance, the wear of the valve stem increases, thereby increasing the movement resistance, making it easy for the valve stem and the guide sleeve to get stuck after wear, and resulting in the fuel injector not spraying fuel or spraying frequently.

In view of this, the embodiment of the present application provides a fuel injector, an engine and a vehicle, which can change the direction of the magnetic force by adjusting the direction of the current put into the electromagnetic drive assembly, thereby driving the needle valve assembly to move away from or close to the fuel injection port. Moreover, the magnetic force generated by the electromagnetic drive assembly can attract or repel the magnetic suspension structure, so that the needle valve assembly remains suspended in the valve cavity and is spaced apart from the inner wall of the valve cavity, thus shielding the metal friction between the valve stem and the valve sleeve. That is, there is no friction between the valve stem and the valve sleeve, thereby reducing the friction and wear of the valve stem, and preventing the valve stem and the valve sleeve from getting stuck, which may cause the fuel injector to not spray fuel or spray frequently, and other abnormal situations. In addition, the present application adopts a magnetic suspension fuel injector, that is, electromagnetic force is used to control the lifting, injection, seating, closing and suspension of the needle valve assembly of the fuel injector, which can prevent the valve stem and the valve sleeve from sliding up and down and causing the jamming and elastic force attenuation.

In order to better understand the above technical solution, the above technical solution is described in detail below with reference to the accompanying drawings.

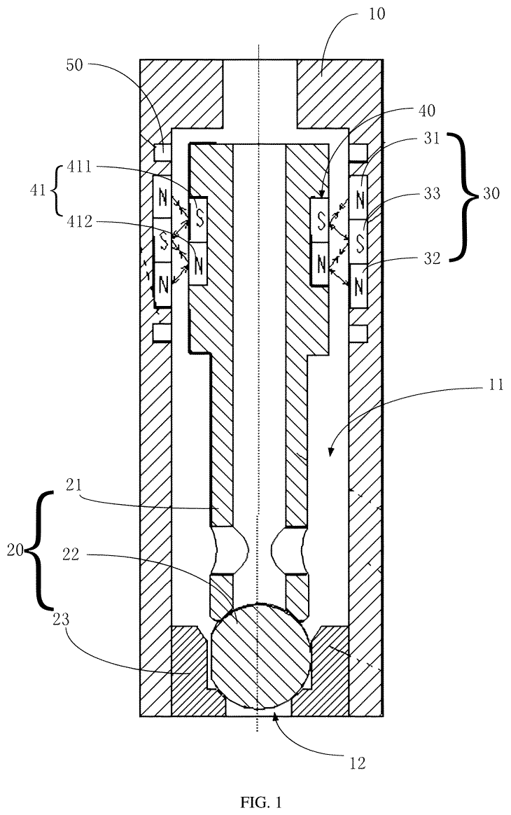

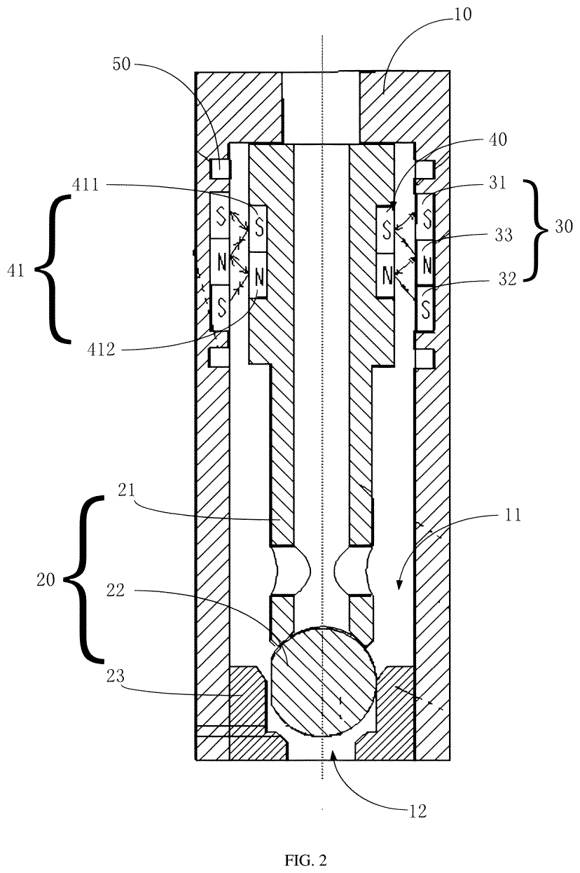

As shown in FIG. 1 and FIG. 2, an embodiment of the present application provides a fuel injector, the fuel injector includes a valve sleeve 10, a needle valve assembly 20, an electromagnetic drive assembly 30 and a magnetic suspension structure 40.

The valve sleeve 10 is provided with a valve cavity 11 and a fuel injection port 12 communicated with the valve cavity 11.

The needle valve assembly 20 is suspended or movably provided in the valve cavity 11, and the outer circumference of the needle valve assembly 20 is spaced apart from the inner wall of the valve cavity 11.

The magnetic suspension structure 40 is provided at the needle valve assembly 20.

The electromagnetic drive assembly 30 is provided at the valve sleeve 10. When powered on, the electromagnetic drive assembly 30 generates magnetic force and cooperates with the magnetic suspension structure 40 to make the needle valve assembly 20 move axially along the valve sleeve 10 in the valve cavity 11 to open or close the fuel injection port 12.

At least three sets of electromagnetic drive assemblies 30 are provided, and at least three sets of electromagnetic drive assemblies 30 are provided along the circumference of the needle valve assembly 20, so that the needle valve assembly 20 is in a suspended state during movement to maintain non-contact with the inner wall of the valve cavity 11.

In the technical solution adopted in the embodiment, a needle valve assembly 20 is provided in the valve cavity 11 of the valve sleeve 10. The needle valve assembly 20 can slide in the valve cavity 11. Through the sliding of the needle valve assembly 20, the fuel injection port 12 can be opened to enter the fuel injection state, or the fuel injection port 12 can be closed to enter the fuel injection stop state. At the same time, an electromagnetic drive assembly 30 is provided in the valve cavity 11, and a magnetic suspension structure 40 is provided at the needle valve assembly 20. The electromagnetic drive assembly 30 will generate magnetic force when powered on, and cooperate with the magnetic suspension structure 40 to make the needle valve assembly 20 slide under the action of the magnetic force, which can prevent the elastic force attenuation generated by conventional spring drive, improve the reliability of the movement of the valve stem 21, and ensure the normal injection of the fuel injector. In other words, by adjusting the direction of the current input into the electromagnetic drive assembly 30, the direction of the magnetic force can be changed, thereby driving the needle valve assembly 20 to move away from or close to the fuel injection port 12. Moreover, the magnetic force generated by the electromagnetic drive assembly 30 can attract or repel the magnetic suspension structure 40, so that the needle valve assembly 20 remains in a suspended state during movement and is spaced apart from the inner wall of the valve cavity 11, thereby shielding the metal friction between the valve stem 21 and the valve sleeve 10, that is, there is no friction between the valve stem 21 and the valve sleeve 10, thereby reducing the friction and wear of the valve stem 21 and preventing the valve stem 21 from getting stuck with the valve sleeve 10, resulting in abnormal situations such as the fuel injector not spraying fuel or spraying fuel frequently.

As shown in FIG. 1 and FIG. 2, in an embodiment of the present application, the magnetic suspension structure 40 includes a permanent magnet 41 provided at the needle valve assembly 20, at least three permanent magnets 41 are provided at intervals along the circumference of the needle valve assembly 20, and each of the permanent magnets 41 is correspondingly provided with a set of the electromagnetic drive assembly 30. That is, the permanent magnet 41 is provided at the needle valve assembly 20, and at least three sets of permanent magnets 41 are provided at intervals along the circumference of the needle valve assembly 20, forming the magnetic suspension structure 40. The permanent magnet 41 has permanent magnetism, and each permanent magnet 41 is correspondingly provided with a set of electromagnetic drive assemblies 30, that is, the electromagnetic drive assemblies 30 are provided with at least three sets, and they are arranged one by one with the permanent magnets 41. It can be understood that at least three sets of electromagnetic drive assemblies 30 generate the same force on the permanent magnets 41 when powered on, that is, the three sets of electromagnetic drive assemblies 30 simultaneously attract or repel the permanent magnets 41 in the radial direction of the needle valve assembly 20, so that the needle valve assembly 20 remains suspended in the space surrounded by the three sets of electromagnetic drive assemblies 30 and is spaced apart from the inner wall of the valve cavity 11, thereby shielding the metal friction between the valve stem 21 and the valve sleeve 10, that is, there is no friction between the valve stem 21 and the valve sleeve 10, thereby reducing the friction and wear of the valve stem 21, and preventing the valve stem 21 from getting stuck with the valve sleeve 10, resulting in abnormal conditions such as the fuel injector not spraying fuel or spraying fuel frequently.

In an embodiment, the axial direction of the valve sleeve 10 extends in the vertical direction. It can be understood that the needle valve assembly 20 slides in the vertical direction. In an embodiment, the electromagnetic drive assembly 30 is provided at the inner wall of the valve sleeve 10. Specifically, the inner wall of the valve sleeve 10 is provided with a mounting groove, and the electromagnetic drive assembly 30 is provided in the mounting groove. The electromagnetic drive assembly 30 is provided with at least three, which can be three, four, five or more. The electromagnetic drive assembly 30 is provided corresponding to the permanent magnet 41, that is, the electromagnetic drive assembly 30 can be provided in three sets, four sets, five sets or more, so that the stability of the needle valve assembly 20 in the suspended state can be improved, thereby preventing deviation. For the convenience of description, the present embodiment takes the arrangement of three permanent magnets 41 and three sets of electromagnetic drive assemblies 30 as an example for explanation. For the arrangement of more than three sets of electromagnetic drive assemblies 30, the arrangement of three sets of electromagnetic drive assemblies 30 can be referred to, and will not be described in detail here. It is understandable that at least three sets of electromagnetic drive assemblies 30 generate magnetic force when powered on, and the magnetic force of the three sets of electromagnetic drive assemblies 30 can simultaneously attract or repel the permanent magnets 41, so that the needle valve assembly 20 remains stable under the action of at least three sets of magnetic forces without contacting the inner wall of the valve sleeve 10, that is, a suspended state is achieved. It should be pointed out that the magnitude of the current input into the three sets of electromagnetic drive assemblies 30 can be the same or different. If the magnitude of the current input into the three sets of electromagnetic drive assemblies 30 is the same, the distance between each side of the needle valve assembly 20 and the inner wall of the valve sleeve 10 is equal. If the magnitude of the current input into the three sets of electromagnetic drive assemblies 30 is different, the distance between each side of the needle valve assembly 20 and the inner wall of the valve sleeve 10 will be different. In specific applications, you can choose the best one, but it is necessary to prevent the needle valve assembly 20 from contacting the inner wall of the valve sleeve 10, and the magnitude of the current input into each set of electromagnetic drive assemblies 30 is not limited here. In order to improve the driving effect of the electromagnetic drive assembly 30 on the needle valve assembly 20, the electromagnetic drive assembly 30 is provided close to the needle valve assembly 20, but the electromagnetic drive assembly 30 and the needle valve assembly 20 are not in direct contact. In other words, the distance between the electromagnetic drive assembly 30 and the needle valve assembly 20 should be as small as possible.

In an embodiment, as shown in FIG. 1 and FIG. 2, in an embodiment of the present application, each set of electromagnetic drive assemblies 30 includes a first electromagnetic coil 31.

The first electromagnetic coil 31 is provided at the inner wall of the valve cavity 11 and is provided opposite to the permanent magnet 41.

The permanent magnet 41 is provided with a first magnetic pole 411 and a second magnetic pole 412 in the movement direction of the needle valve assembly 20. The direction of the magnetic force generated by the first electromagnetic coil 31 is adjustable by changing the direction of the current, and the first electromagnetic coil 31 cooperates with the first magnetic pole 411 or the second magnetic pole 412 to drive the needle valve assembly 20 to move away from or close to the fuel injection port 12. The magnetic force directions generated by the first electromagnetic coils 31 in a plurality sets of the electromagnetic drive assemblies 30 when energized are in a same direction, so as to simultaneously attract or repel the needle valve assembly 20, and the needle valve assembly 20 is in a suspended state.

In an embodiment, each set of electromagnetic drive assemblies 30 includes a first electromagnetic coil 31 and a permanent magnet 41. The permanent magnet 41 is provided at the outer peripheral surface of the needle valve assembly 20. In an embodiment, the permanent magnet 41 is detachably connected to the needle valve assembly 20, which can improve the convenience of disassembly and assembly. The permanent magnet 41 always has magnetic force. In the movement direction of the needle valve assembly 20, the permanent magnet 41 is provided with a first magnetic pole 411 and a second magnetic pole 412. One of the first magnetic pole 411 and the second magnetic pole 412 is an N pole, and the other of the first magnetic pole 411 and the second magnetic pole 412 is an S pole. For the convenience of description, the magnetic pole of the permanent magnet 41 close to the fuel injection port 12 is defined as the first magnetic pole 411, and the magnetic pole of the permanent magnet 41 away from the fuel injection port 12 is defined as the second magnetic pole 412. The first electromagnetic coil 31 is provided at the inner wall of the valve sleeve 10. The first electromagnetic coil 31 can generate magnetic force or magnetism when powered on. By adjusting the direction of the current input into the first electromagnetic coil 31, the magnetic force or magnetism can be changed, thereby cooperating with the permanent magnet 41 to drive the needle valve assembly 20 to move away from or close to the fuel injection port 12. It should be pointed out that the direction of the current input into the first electromagnetic coils 31 of at least three sets of electromagnetic drive assemblies 30 at the same time is the same, and the current magnitude can be the same or different. In an embodiment, the first electromagnetic coils 31 of at least three sets of electromagnetic drive assemblies 30 are located on the same plane.

In an embodiment, the first electromagnetic coil 31 is provided close to the first magnetic pole 411 of the permanent magnet 41, and the straight-line distance between the end of the first magnetic pole 411 away from the second magnetic pole 412 and the fuel injection port 12 is less than the straight-line distance between the end of the first electromagnetic coil 31 away from the fuel injection port 12 and the fuel injection port 12, where the straight-line distance is the length in the movement direction of the needle valve assembly 20. It can be understood that at this time, the end of the first magnetic pole 411 away from the second magnetic pole 412 is lower than the end of the first electromagnetic coil 31 away from the fuel injection port 12. In this way, when the first electromagnetic coil 31 is supplied with current in different directions, the magnetic force generated by the first electromagnetic coil 31 is attracted to the first magnetic pole 411 to drive the needle valve assembly 20 to move away from the fuel injection port 12, or the magnetic force generated by the first electromagnetic coil 31 is repelled from the first magnetic pole 411 to drive the needle valve assembly 20 to move toward the fuel injection port 12.

In an embodiment, the first electromagnetic coil 31 is provided close to the second magnetic pole 412 of the permanent magnet 41, and the straight-line distance between the end of the second magnetic pole 412 of the permanent magnet 41 away from the first magnetic pole 411 and the fuel injection port 12 is greater than the straight-line distance between the end of the first electromagnetic coil 31 facing the fuel injection port 12 and the fuel injection port 12, where the straight-line distance is the length in the movement direction of the needle valve assembly 20. It can be understood that at this time, the end of the second magnetic pole 412 away from the first magnetic pole 411 is higher than the end of the first electromagnetic coil 31 facing the fuel injection port 12. In this way, when the first electromagnetic coil 31 is supplied with currents in different directions, the magnetic force generated by the first electromagnetic coil 31 attracts the second magnetic pole 412 to drive the needle valve assembly 20 to move toward the fuel injection port 12, or the magnetic force generated by the first electromagnetic coil 31 repels the second magnetic pole 412 to drive the needle valve assembly 20 to move away from the fuel injection port 12.

In an embodiment, as shown in FIG. 1 and FIG. 2, in an embodiment of the present application, each set of electromagnetic drive assemblies 30 further includes second electromagnetic coil 32.

The first electromagnetic coil 31 and the second electromagnetic coil 32 are stacked in the movement direction of the needle valve assembly 20, and the magnetic forces generated by the first electromagnetic coil 31 and the second electromagnetic coil 32 when energized are in the same direction, the magnetic force generated by the first electromagnetic coil 31 cooperates with the first magnetic pole 411 and the magnetic force generated by the second electromagnetic coil 32 cooperates with the second magnetic pole 412 to jointly drive the needle valve assembly 20 to move toward or away from the fuel injection port 12.

In an embodiment, each set of electromagnetic drive assemblies 30 further includes a second electromagnetic coil 32, and the first electromagnetic coil 31 and the second electromagnetic coil 32 are stacked in the movement direction of the needle valve assembly 20. For the convenience of description, the first electromagnetic coil 31 is defined as being provided at the side of the second electromagnetic coil 32 away from the fuel injection port 12. In the embodiment, the straight-line distance between the end of the first magnetic pole 411 away from the second magnetic pole 412 and the fuel injection port 12 is less than the straight-line distance between the end of the first electromagnetic coil 31 away from the fuel injection port 12 and the fuel injection port 12, where the straight-line distance is the length in the movement direction of the needle valve assembly 20. It can be understood that at this time, the end of the first magnetic pole 411 away from the second magnetic pole 412 is lower than the end of the first electromagnetic coil 31 away from the fuel injection port 12. The straight-line distance between the end of the second magnetic pole 412 of the permanent magnet 41 away from the first magnetic pole 411 and the fuel injection port 12 is greater than the straight-line distance between the end of the second electromagnetic coil 32 away from the first electromagnetic coil 31 and the fuel injection port 12, where the straight-line distance is the length in the movement direction of the needle valve assembly 20. It can be understood that at this time, the end of the second magnetic pole 412 away from the first magnetic pole 411 is higher than the end of the second electromagnetic coil 32 away from the first electromagnetic coil 31. In this way, when the first electromagnetic coil 31 and the second electromagnetic coil 32 are supplied with current, the magnetic force generated by the first electromagnetic coil 31 attracts the first magnetic pole 411 and the magnetic force generated by the second electromagnetic coil 32 repels the second magnetic pole 412 to jointly drive the needle valve assembly 20 to move away from the fuel injection port 12, or the magnetic force generated by the first electromagnetic coil 31 repels the first magnetic pole 411 and the magnetic force generated by the second electromagnetic coil 32 attracts the second magnetic pole 412 to jointly drive the needle valve assembly 20 to move toward the fuel injection port 12. In other words, the two forces generated by the first electromagnetic coil 31 and the second electromagnetic coil 32 on the permanent magnet 41 can provide sufficient driving force for the movement of the needle valve assembly 20, thereby ensuring the normal movement of the needle valve assembly 20, and preventing getting stuck and abnormal fuel injection. It should be pointed out that in the embodiment, the current direction of the first electromagnetic coil 31 and the second electromagnetic coil 32 at the same time is the same. In addition, the first electromagnetic coils 31 in at least three sets of electromagnetic drive assemblies 30 are in the same plane and the second electromagnetic coils 32 are also in the same plane.

As shown in FIG. 1 and FIG. 2, in an embodiment of the present application, each set of electromagnetic drive assemblies 30 further includes a third electromagnetic coil 33.

The first electromagnetic coil 31, the third electromagnetic coil 33 and the second electromagnetic coil 32 are stacked in the movement direction of the needle valve assembly 20. The direction of the magnetic force generated by the third electromagnetic coil 33 when energized is different from the direction of the magnetic force generated by the first electromagnetic coil 31 when energized. The magnetic force generated by the first electromagnetic coil 31 cooperates with the first magnetic pole 411, the magnetic force generated by the second electromagnetic coil 32 cooperates with the second magnetic pole 412, and the magnetic force generated by the third electromagnetic coil 33 cooperates with the first magnetic pole 411 and the second magnetic pole 412 to jointly drive the needle valve assembly 20 to move toward or away from the fuel injection port 12.

In an embodiment, each set of electromagnetic drive assemblies 30 further includes a third electromagnetic coil 33, which is provided between the first electromagnetic coil 31 and the second electromagnetic coil 32. In the embodiment, the straight-line distance between the end of the third electromagnetic washer facing the first electromagnetic coil 31 and the fuel injection port 12 is greater than the straight-line distance between the end of the second magnetic pole 412 facing the first magnetic pole 411 and the fuel injection port 12, and the distance between the end of the third electromagnetic coil 33 facing the second electromagnetic coil 32 and the fuel injection port 12 is greater than the straight-line distance between the end of the second magnetic pole 412 facing away from the first magnetic pole 411 and the fuel injection port 12, where the straight-line distance is the length in the movement direction of the needle valve assembly 20. It can be understood that at this time, the end of the third electromagnetic coil 33 facing the first electromagnetic coil 31 is higher than the end of the second magnetic pole 412 facing the first magnetic pole 411, and the end of the third electromagnetic coil 33 facing away from the first electromagnetic coil 31 is higher than the end of the second magnetic pole 412 facing away from the first magnetic pole 411.

That is, the boundary line between the first magnetic pole 411 and the second magnetic pole 412 is provided corresponding to the third electromagnetic coil 33, so that the magnetic force generated by the third electromagnetic coil 33 when energized can act on the first magnetic pole 411 and the second magnetic pole 412 at the same time. In this way, when the first electromagnetic coil 31, the second electromagnetic coil 32 and the third electromagnetic coil 33 are energized, the magnetic force generated by the first electromagnetic coil 31 attracts the first magnetic pole 411, the magnetic force generated by the second electromagnetic coil 32 repels the second magnetic pole 412, the magnetic force generated by the third electromagnetic coil 33 repels the first magnetic pole 411, and the magnetic force generated by the third electromagnetic coil 33 attracts the second magnetic pole 412 to jointly drive the needle valve assembly 20 to move away from the fuel injection port 12, or the magnetic force generated by the first electromagnetic coil 31 repels the first magnetic pole 411, the magnetic force generated by the second electromagnetic coil 32 attracts the second magnetic pole 412, the magnetic force generated by the third electromagnetic coil 33 attracts the first magnetic pole 411, and the magnetic force generated by the third electromagnetic coil 33 repels the second magnetic pole 412 to jointly drive the needle valve assembly 20 to move toward the fuel injection port 12. That is, the four forces on the permanent magnet 41 generated by the first electromagnetic coil 31, the second electromagnetic coil 32 and the third electromagnetic coil 33 can further provide sufficient driving force for the movement of the needle valve assembly 20, further ensure the normal movement of the needle valve assembly 20, and prevent the abnormal injection caused by getting stuck.

It should be pointed out that in the embodiment, at the same time, the currents passing through the first electromagnetic coil 31 and the second electromagnetic coil 32 are in the same direction, and the current passing through the third electromagnetic coil 33 is different from that of the first electromagnetic coil 31. In addition, the first electromagnetic coils 31 in at least three sets of electromagnetic drive assemblies 30 are in the same plane, the second electromagnetic coils 32 in at least three sets of electromagnetic drive assemblies 30 are in the same plane, and the third electromagnetic coils 33 in at least three sets of electromagnetic drive assemblies 30 are also in the same plane.

In an embodiment, as shown in FIG. 1 and FIG. 2, in an embodiment of the present application, the fuel injector also includes a gap sensor 50, which is provided at the inner wall of the valve cavity 11 to detect the distance between the outer wall of the needle valve assembly 20 and the inner wall of the valve cavity 11, and each set of electromagnetic drive assemblies 30 is correspondingly provided with a gap sensor 50.

In an embodiment, the fuel injector further includes a gap sensor 50. Each set of electromagnetic drive assemblies 30 is provided with a gap sensor 50. The gap sensor 50 can monitor the tendency of the needle valve assembly 20 to collide with the inner wall of the valve sleeve 10 in real time, and then adjust the magnitude of the current input into the corresponding set of electromagnetic drive assemblies 30. For example, the first set of electromagnetic drive assemblies 30, the second set of electromagnetic drive assemblies 30 and the third set of electromagnetic drive assemblies 30 are provided at intervals along the circumference of the needle valve assembly 20. The first gap sensor 50 is correspondingly provided with the first set of electromagnetic drive assemblies 30, the second gap sensor 50 is correspondingly provided with the second set of electromagnetic drive assemblies 30, and the third gap sensor 50 is correspondingly provided with the third set of electromagnetic drive assemblies 30. If the value detected by the first gap sensor 50 is smaller than the value detected by the second gap sensor 50 and also smaller than the value detected by the third gap sensor 50, it means that the magnetic force of the first set of electromagnetic drive assemblies 30 is relatively large, and the current input into the first set of electromagnetic drive assemblies 30 needs to be reduced. With the arrangement, the magnitude of the current is controlled according to the real-time monitoring of the air gap sensor, so that each set of electromagnetic drive assemblies 30 generates an appropriate amount of magnetic force, thereby ensuring the needle valve assembly 20 is suspended in the valve sleeve 10 and is spaced apart from the inner wall of the valve sleeve 10, and preventing the needle valve assembly 20 from being worn caused by contact.

In an embodiment, each set of electromagnetic drive assemblies 30 may be provided with a corresponding gap sensor 50, and the gap sensor 50 may be provided above the first electromagnetic coil 31 or below the first electromagnetic coil 31. In an embodiment, each set of electromagnetic drive assemblies 30 may be provided with two gap sensors 50, one of the two gap sensors 50 is provided above the first electromagnetic coil 31, and the other of the two gap sensors 50 is provided below the first electromagnetic coil 31, so that the accuracy of the gap detection result can be improved.

For example, in an embodiment of the present application, the fuel injector further includes a control unit, the gap sensor 50 and the electromagnetic drive assembly 30 are electrically connected to the control unit, and the control unit adjusts the current value input to the electromagnetic drive assembly 30 according to the detection value of the gap sensor 50. The arrangement replaces manual adjustment, can realize automatic adjustment of the current, improve the efficiency of current adjustment, and effectively reduce the risk of contact between the needle valve assembly 20 and the valve sleeve 10.

As shown in FIG. 1 and FIG. 2, in an embodiment of the present application, the needle valve assembly 20 includes a valve stem 21, a sealing ball 22 and a ball seat 23.

The permanent magnet 41 is provided at the valve stem 21, the outer circumference of the valve stem 21 is spaced apart from the inner wall of the valve cavity 11, and a plurality sets of electromagnetic drive assemblies 30 are provided along the circumference direction of the valve stem 21.

The sealing ball 22 is provided at an end of the valve stem 21 close to the fuel injection port 12.

The ball seat 23 is provided in the valve cavity 11 and is provided with a sealing hole communicating the fuel injection port 12 and the valve cavity 11, and the sealing ball 22 cooperates with the sealing hole.

In an embodiment, the needle valve assembly 20 includes a valve stem 21, a sealing ball 22 and a ball seat 23. The permanent magnet 41 is provided at the valve stem 21, and the valve stem 21 moves under the action of the magnetic force, so that the sealing ball 22 is inserted into the sealing hole or separated from the sealing hole, thereby realizing or stopping the fuel injection. It can be understood that the sealing effect can be improved and fuel leakage can be prevented by the cooperation between the sealing ball 22 and the ball seat 23.

In an embodiment, in an embodiment of the present application, the valve stem 21 is provide with an driving section and a sealing section adjacent to the driving section, a permanent magnet 41 is provided at the driving section, a plurality sets of electromagnetic drive assemblies 30 are provided along the circumference of the driving section, a sealing ball 22 is provided at an end of the sealing section away from the driving section, the outer diameter of the driving section is greater than the outer diameter of the sealing section, and the driving section and the sealing section are spaced apart from the inner wall of the valve cavity 11. Such an arrangement can reduce the overall weight of the valve stem 21 and ensure the reliable movement of the valve stem 21. Moreover, the permanent magnet 41 is provided in the driving section, which can reduce the distance between the permanent magnet 41 and the coil, improve the effect of the magnetic force generated by the coil when energized on the permanent magnet 41, further improve the stability and reliability of the movement of the valve stem 21, and prevent getting stuck.

To achieve the above purpose, the embodiment of the present application proposes an engine, which includes the fuel injector described above. Specifically, the specific structure of the fuel injector refers to the above embodiment. Since the engine adopts all the technical solutions of the above embodiment, it at least has all the beneficial effects brought by the technical solutions of the above embodiment, which will not be repeated here.

To achieve the above purpose, the embodiment of the present application proposes a vehicle, which includes the engine described above. Specifically, the specific structure of the engine refers to the above embodiment. Since the vehicle adopts all the technical solutions of the above embodiment, it at least has all the beneficial effects brought by the technical solutions of the above embodiment, which will not be repeated here.

The above description is only an embodiment of the present application, and does not limit the patent scope of the embodiments of the present application. All equivalent structural transformations made by using the contents of the description and drawings of the embodiments of the present application under the inventive concept of the embodiments of the present application, or direct/indirect application in other related technical fields are included in the patent protection scope of the embodiments of the present application.

What is claimed is:

1. A fuel injector, comprising:
a valve sleeve provided with a valve cavity and a fuel injection port communicated with the valve cavity;
a needle valve assembly suspended or movably provided in the valve cavity;
an electromagnetic drive assembly provided at the valve sleeve; and
a magnetic suspension structure provided at the needle valve assembly,
wherein an outer circumference of the needle valve assembly is spaced apart from an inner wall of the valve cavity; and
the electromagnetic drive assembly generates magnetic force when powered on and cooperates with the magnetic suspension structure to make the needle valve assembly move axially along the valve sleeve in the valve cavity to open or close the fuel injection port.

2. The fuel injector according to claim 1, wherein the magnetic suspension structure comprises a permanent magnet provided at the needle valve assembly, at least three permanent magnets are provided at intervals along a circumference of the needle valve assembly, and each of the permanent magnets is correspondingly provided with a set of the electromagnetic drive assemblies.

3. The fuel injector according to claim 1, wherein each set of the electromagnetic drive assemblies comprises a first electromagnetic coil and the permanent magnet, the first electromagnetic coil is provided at the inner wall of the valve cavity and is provided opposite to the permanent magnet;
the permanent magnet is provided at the needle valve assembly, and the permanent magnet is provided with a first magnetic pole and a second magnetic pole in a movement direction of the needle valve assembly;
a direction of the magnetic force generated by the first electromagnetic coil is adjustable by changing a direction of the current, and the first electromagnetic coil cooperates with the first magnetic pole or the second magnetic pole to drive the needle valve assembly to move away from or close to the fuel injection port;
the magnetic forces generated by the first electromagnetic coils in a plurality sets of the electromagnetic drive assemblies when energized are in a same direction, and simultaneously attract or repel the needle valve assembly, and the needle valve assembly is in a suspended state.

4. The fuel injector according to claim 3, wherein each set of the electromagnetic drive assemblies further comprises a second electromagnetic coil, the first electromagnetic coil and the second electromagnetic coil are stacked in the movement direction of the needle valve assembly, the magnetic forces generated by the first electromagnetic coil and the second electromagnetic coil when energized are in a same direction, the magnetic force generated by the first electromagnetic coil cooperates with the first magnetic pole and the magnetic force generated by the second electromagnetic coil cooperates with the second magnetic pole to jointly drive the needle valve assembly to move toward or away from the fuel injection port.

5. The fuel injector according to claim 4, wherein each set of the electromagnetic drive assemblies further comprises a third electromagnetic coil, the first electromagnetic coil, the third electromagnetic coil and the second electromagnetic coil are stacked in the movement direction of the needle valve assembly;
a direction of a magnetic force generated by the third electromagnetic coil when energized is different from the direction of the magnetic force generated by the first electromagnetic coil when energized;
the magnetic force generated by the first electromagnetic coil cooperates with the first magnetic pole, the magnetic force generated by the second electromagnetic coil cooperates with the second magnetic pole, and the magnetic force generated by the third electromagnetic coil cooperates with the first magnetic pole and the second magnetic pole to jointly drive the needle valve assembly to move toward or away from the fuel injection port.

6. The fuel injector according to claim 1, further comprising a gap sensor,
wherein the gap sensor is provided at the inner wall of the valve cavity to detect a distance between an outer wall of the needle valve assembly and the inner wall of the valve cavity, and each set of the electromagnetic drive assembly is correspondingly provided with a gap sensor.

7. The fuel injector according to claim 6, further comprising a control unit,
wherein the gap sensor and the electromagnetic drive assembly are both electrically connected to the control unit, and the control unit is configured to adjust a current value input to the electromagnetic drive assembly according to a detection value of the gap sensor.

8. The fuel injector according to claim 3, wherein the needle valve assembly comprises a valve stem, a sealing ball and a ball seat;
the permanent magnet is provided at the valve stem, an outer circumference of the valve stem is spaced apart from the inner wall of the valve cavity, and a plurality sets of the electromagnetic drive assemblies are provided along a circumference direction of the valve stem;
the sealing ball is provided at an end of the valve stem close to the fuel injection port; and
the ball seat is provided with a sealing hole communicating with the fuel injection port and the valve cavity, the sealing ball cooperates with the sealing hole.

9. The fuel injector according to claim 8, wherein the valve stem is provide with a driving section and a sealing section adjacent to the driving section, the permanent magnet is provided at the driving section, the plurality sets of the electromagnetic drive assemblies are provided along a circumference of the driving section, the sealing ball is provided at an end of the sealing section away from the driving section, an outer diameter of the driving section is greater than an outer diameter of the sealing section, and the driving section and the sealing section are spaced apart from the inner wall of the valve cavity.

10. An engine, comprising the fuel injector according to claim 1.

11. A vehicle, comprising the engine according to claim 10.
